(19) United States
(12) Patent Application Publication
(10) Pub. No.: US 2020/0201227 A1
(43) Pub. Date: Jun. 25, 2020

(54) IMAGE FORMING APPARATUS AND IMAGE FORMING METHOD

(71) Applicant: TOSHIBA TEC KABUSHIKI KAISHA, Tokyo (JP)

(72) Inventor: Yoji Sato, Izunokuni Shizuoka (JP)

(73) Assignee: TOSHIBA TEC KABUSHIKI KAISHA, Tokyo (JP)

(21) Appl. No.: 16/228,266

(22) Filed: Dec. 20, 2018

(51) Int. Cl. G03G 15/00; G06Q 10/10; G06Q 30/06

(52) U.S. Cl. CPC G03G 15/556; G06Q 30/0633; G06Q 10/1097

(57) ABSTRACT

In accordance with an embodiment, an image forming apparatus comprises a decision section configured to decide an order scheduled time of a consumable commodity based on a time point at which a condition relating to replacement of the consumable commodity is satisfied since the consumable commodity is mounted. The decision section changes the order scheduled time based on the number of sheets printed in a predetermined period after the time point at which the condition is satisfied.

### FIELD

Embodiments described here relate generally to an image forming apparatus and an image forming method.

### BACKGROUND

A MFP (Multifunction Peripheral) forms an image by transferring a toner image onto a sheet. Since the MFP cannot perform printing when a toner is empty (hereinafter, referred to as an “empty state”), it is necessary to have the toner for replacement at hand at the time of entering the empty state for a user. In the MFP, for example, a toner used in the control of the inside of the apparatus to stabilize an image density, and a toner powder remaining on a transfer belt without being transferred onto a sheet at the time of printing are collected in a container for waste toner (hereinafter referred to as a “waste toner container”) as waste toner. Since the MFP cannot perform the printing in a state in which the waste toner container becomes full (hereinafter referred to as a “full state”), it is necessary to have the waste toner container for replacement at hand when the waste toner container enters the full state.

Conventionally, an automatic ordering system detects the empty state of the toner or the full state of the waste toner container, and automatically orders the toner or the waste toner container. In order to monitor an amount of the toner used in a toner container, the automatic ordering system acquires measured values of a rotation time and a rotation speed of a motor that drives the toner. In order to monitor a waste toner amount, the automatic ordering system acquires the waste toner amount as a measured value with sensors such as an optical system sensor and a weight sensor. If each measured value acquired reaches a threshold value thereof, the automatic ordering system automatically orders the toner or the waste toner container.

However, in the conventional automatic ordering system, an order timing is constant. Therefore, if a frequency of use of the MFP by the user changes, there is a problem that the order is delayed and the component cannot be delivered in time, or a period during which the user holds the component in the inventory is increased due to the early order.

### DESCRIPTION OF THE DRAWINGS

FIG. 1 is an external view illustrating an example of an overall configuration of an image forming apparatus 100 according to an embodiment;

FIG. 2 is a block diagram illustrating functions of an image forming apparatus 100a according to a first embodiment;

FIG. 3 is a diagram illustrating data structures of specific examples of data relating to the number of printed sheets and rotation speed per day according to the first embodiment;

FIG. 4 is a graph illustrating a relationship between the number of printed sheets and the time length of an order scheduled time according to the embodiment;

FIG. 5 is a flowchart depicting a flow of a toner order processing according to the first embodiment;

FIG. 6 is a block diagram illustrating functions of an image forming apparatus 100b according to a second embodiment;

FIG. 7 is a diagram illustrating data structures of specific examples of data relating to the number of printed sheets and waste toner amount per day according to the second embodiment;

FIG. 8 is a flowchart depicting a flow of an order processing of a waste toner container according to the second embodiment;

FIG. 9 is a diagram schematically illustrating a system configuration of an image forming system 500 according to a third embodiment;

FIG. 10 is a diagram schematically illustrating a system configuration of an image forming system 600 according to a fourth embodiment;

FIG. 11 is a block diagram illustrating functions of an image forming apparatus 101a according to the fourth embodiment;

FIG. 12 is a block diagram illustrating functions of the image forming apparatus 101b according to the fourth embodiment; and

FIG. 13 is a block diagram illustrating functions of a server 150 according to the fourth embodiment.

### DETAILED DESCRIPTION

In accordance with an embodiment, an image forming apparatus comprises an acquisition section configured to acquire time length information indicating a predetermined period and sheet quantity information indicating the number of printed sheets printed in the period; a decision section configured to decide an order scheduled time based on the time length information and the sheet quantity information, and to update the order scheduled time based on the sheet quantity information if the sheet quantity information exceeds a predetermined threshold value.

Hereinafter, an image forming apparatus and an image forming method of an embodiment are described with reference to the accompanying drawings.

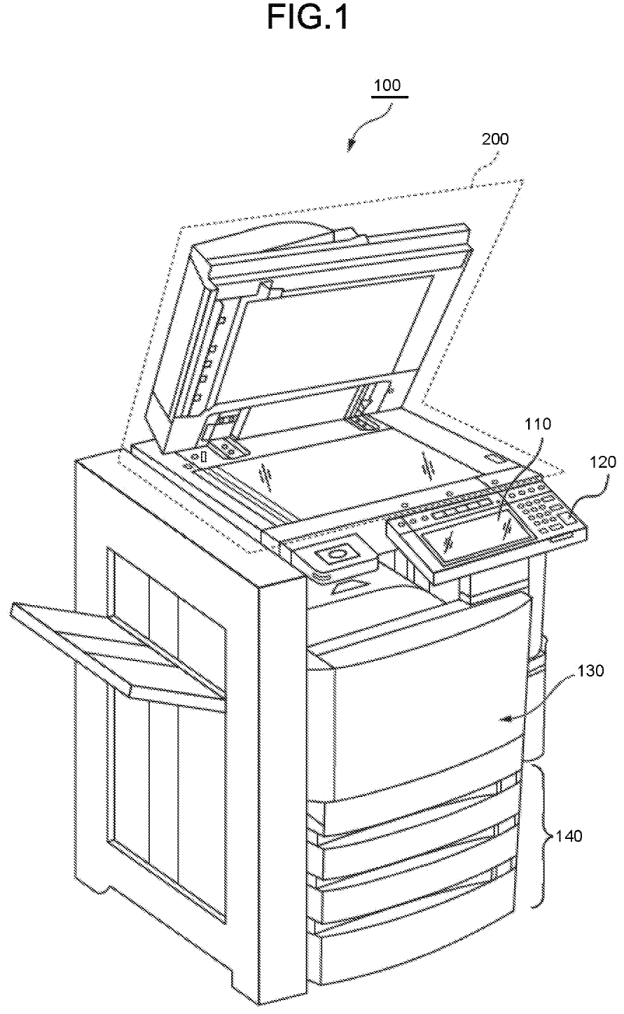

FIG. 1 is a schematic external view illustrating an example of an overall configuration of an image forming apparatus 100 according to the embodiment. The image forming apparatus 100 is, for example, a MFP (Multi-Function Peripheral). The image forming apparatus 100 includes a display 110, a control panel 120, a printer 130, a sheet housing section 140 and an image reading section 200. Furthermore, the printer 130 of the image forming apparatus 100 may be a device for fixing a toner image or an inkjet type device.

The image forming apparatus 100 forms an image on a sheet using a developer such as a toner. The sheet is, for example, a paper or a label paper. Any type of sheet can be used as long as the image forming apparatus 100 can form an image on the surface of the sheet.

The display 110 is an image display device such as a liquid crystal display, an organic EL (Electro Luminescence) display and the like. The display 110 is configured to display various information relating to the image forming apparatus 100.

The control panel 120 includes a plurality of buttons. The control panel 120 receives an operation input from a user. The control panel 120 outputs a signal corresponding to an operation input by the user to a controller of the image forming apparatus 100. The display 110 and the control panel 120 may be integrated with each other to form a touch panel.

The printer 130 forms an image on the sheet based on image information generated by the image reading section 200 or image information received through a communication path. The printer 130 forms an image through the following processing, for example. An image forming section of the printer 130 forms an electrostatic latent image on a photoconductive drum based on the image information. The image forming section of the printer 130 forms a visible image by attaching a developer to the electrostatic latent image. The toner is provided as a specific example of the developer. A transfer section of the printer 130 transfers the visible image onto the sheet. A fixing section of the printer 130 fixes the visible image on the sheet by heating and pressurizing the sheet. The sheet on which the image is formed may be a sheet accommodated in the sheet housing section 140, or a sheet that is manually fed.

The sheet housing section 140 houses the sheet used for the image formation by the printer 130.

The image reading section 200 reads the image information of a reading object as intensity of light. The image reading section 200 records the read image information. The recorded image information may be transmitted to another information processing apparatus via a network. The recorded image information may be used for the image formation on the sheet by the printer 130.

### First Embodiment

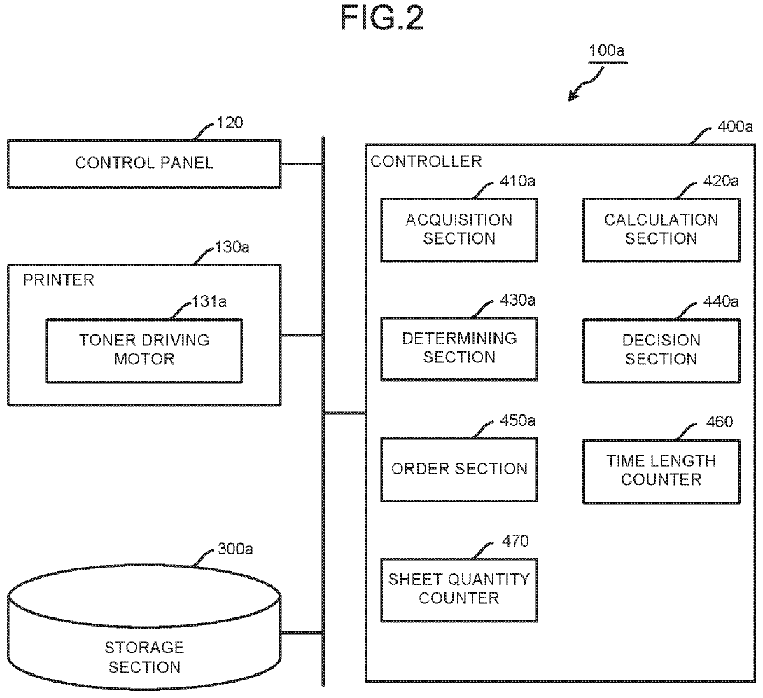

FIG. 2 is a block diagram illustrating functions of an image forming apparatus 100a according to the first embodiment. The image forming apparatus 100a comprises the control panel 120, a printer 130a, a storage section 300a and a controller 400a. The control panel 120 is the same as that shown in FIG. 1, and the description thereof is omitted here.

The printer 130a includes a toner driving motor 131a. The toner driving motor 131a is, for example, a motor for replenishment of a recording material which rotates a screw arranged in a toner container. By counting a rotation speed of the toner driving motor 131a, a printing amount can be estimated from a replenished amount of the recording material. The toner container includes a toner cartridge and a toner bottle.

The storage section 300a is a storage device such as a magnetic hard disk device or a semiconductor storage device. The storage section 300a previously stores a printing limit number indicating the maximum number of printed sheets that can be printed before the toner container changes from the full state to the empty state. The storage section 300a stores, for example, a toner container table in which a predetermined period, the number of printed sheets in the predetermined period, and the rotation speed of the toner driving motor 131a are stored.

The controller 400a is a processor such as a CPU (Central Processing Unit). By executing a program by the processor, the controller 400a functions as an acquisition section 410a, a calculation section 420a, a determining section 430a, a decision section 440a, an order section 450a, a time length counter 460 and a sheet quantity counter 470.

The acquisition section 410a acquires first time length information, second time length information, first sheet quantity information, and second sheet quantity information. The first time length information indicates the time length in a period until the transition to a pre-near empty state since the replacement of the toner container. The pre-near empty state refers to a state in a period until the transition to a near empty state in which an order or a warning is issued since the rotation speed of the toner driving motor 131a exceeds a predetermined threshold value. The near empty state indicates a state in a period until the transition to the empty state since predetermined threshold value set for the remaining amount of the toner is exceeded. The second time length information indicates the time length since the transition to the pre-near empty state to the transition to the empty state.

The first sheet quantity information indicates the number of printed sheets printed in the period indicated by the first time length information. The second sheet quantity information indicates the number of printed sheets obtained by subtracting the number of printed sheets indicated by the first sheet quantity information from the printing limit number. The acquisition section 410a acquires the rotation speed from the toner driving motor 131a. The acquisition section 410a transmits the first time length information, the second time length information, the first sheet quantity information, the second sheet quantity information, and the rotation speed to the calculation section 420a and the determining section 430a. The acquisition section 410a may store the acquired data in the storage section 300a.

The calculation section 420a calculates a usage ratio indicating a usage amount per unit day based on the number of printed sheets printed within a predetermined period from the day when shifting to the pre-near empty state. For example, the calculation section 420a may calculate an average of the number of printed sheets per day in the period indicated by the first time length information based on the first time length information and the first sheet quantity information as a first usage ratio.

After the transition to the pre-near empty state, the calculation section 420a calculates an average of the number of printed sheets in a predetermined period as a second usage ratio at a predetermined timing. In the following description, as an example, the predetermined period is described as one day. After the transition to the pre-near empty state, the calculation section 420a calculates the second usage ratio from the count by the time length counter 460 and the sheet quantity counter 470.

Based on the rotation speed of the toner driving motor 131a, the determining section 430a determines whether or not the rotation speed exceeds a predetermined threshold value of the rotation speed. The determining section 430a determines that the toner container shifts to the pre-near empty state if the rotation speed of the toner driving motor 131a exceeds the predetermined threshold value. The determining section 430a determines that the toner container does not shift to the pre-near empty state if the rotation speed of the toner driving motor 131a is less than the predetermined threshold value.

In the case in which the toner container shifts to the pre-near empty state, the determining section 430a determines an increase/decrease threshold value based on the first usage ratio calculated by the calculation section 420a. The increase/decrease threshold value refers to a threshold value relating to the second usage ratio. The upper and lower limits of the increase/decrease threshold value are set, for example, by multiplying the first usage ratio by a predetermined value.

If the second usage ratio exceeds the increase/decrease threshold value, the determining section 430a transmits a command of changing an order scheduled time to the decision section 440a based on the second usage ratio. If the second usage ratio does not exceed the increase/decrease threshold value, i.e., if the second usage ratio is within a range of the increase/decrease threshold value, the determining section 430a waits for update of the second usage ratio again.

Based on the second time length information, the determining section 430a determines whether or not the length of elapsed days exceeds a toner order time. If the length of elapsed days exceeds the toner order time, the determining section 430a transmits a command for ordering the toner to the order section 450a. If the length of elapsed days does not exceed the toner order time, the determining section 430a updates the second time length information based on the count by the time length counter 460 and makes a determination again.

The decision section 440a decides the order scheduled time based on a time point at which a condition for replacing a consumable commodity (toner container) is satisfied since the consumable commodity is mounted. The condition for replacing a consumable commodity is a criteria for replacement of the consumable commodity, such as the rotation speed of the motor, a remaining amount of the toner container, a waste toner amount, the number of printed sheet, or the like. For example, the decision section 440a decides the order scheduled time based on the second time length information and the second sheet quantity information. The decision section 440a may decide the order scheduled time based on the first usage ratio.

If the command for changing the order scheduled time is received from the determining section 430a, the decision section 440a updates the order scheduled time. At this time, if the number of printed sheets per day according to the second usage ratio increases when compared with the first usage ratio, the decision section 440a decides to bring the order scheduled time forward. If the number of printed sheets per day according to the second usage ratio decreases when compared with the first usage ratio, the decision section 440a decides to put off the order scheduled time.

The decision section 440a decides the order scheduled time according to the prescribed number of printed sheets if the usage ratio calculated in the calculation section 420a is not used. Specifically, if the number of printed sheets is 0 to 500 in a predetermined period (for example, 10 days), the decision section 440a decides to put off the order scheduled time by 10 days. For example, the decision section 440a does not change the order scheduled time if the number of printed sheets is 501 to 1000. For example, the decision section 440a decides to bring the order scheduled time forward by 10 days if the number of printed sheets is 1001 to 1500.

The order section 450a orders the toner based on the order scheduled time decided by the decision section 440a. If the order scheduled time is changed, the order section 450a orders the toner based on the changed order scheduled time. The order section 450a outputs the near empty state to an image display device such as the control panel 120.

The time length counter 460 counts the time length elapsing since the replacement of the toner container. In the first embodiment, as an example, an update period of the time length counter 460 is set to one day. The time length counter 460 increases the count by one every day. The time length counter 460 stores the time length counted until the transition to the pre-near empty state as the first time length information in the storage section 300a. The time length counter 460 stores the time length counted from the pre-near empty state to the empty state in the storage section 300a as the second time length information.

The sheet quantity counter 470 counts the number of sheets printed by the image forming apparatus 100a. The sheet quantity counter 470 stores the number of printed sheets in the storage section 300a at a timing when the time length counter 460 increases the count, and resets the count of the number of printed sheets. For example, when the time length counter 460 counts the time length for one day, the sheet quantity counter 470 stores the count of the number of printed sheets in the storage section 300a, and sets the count of the number of printed sheets to 0.

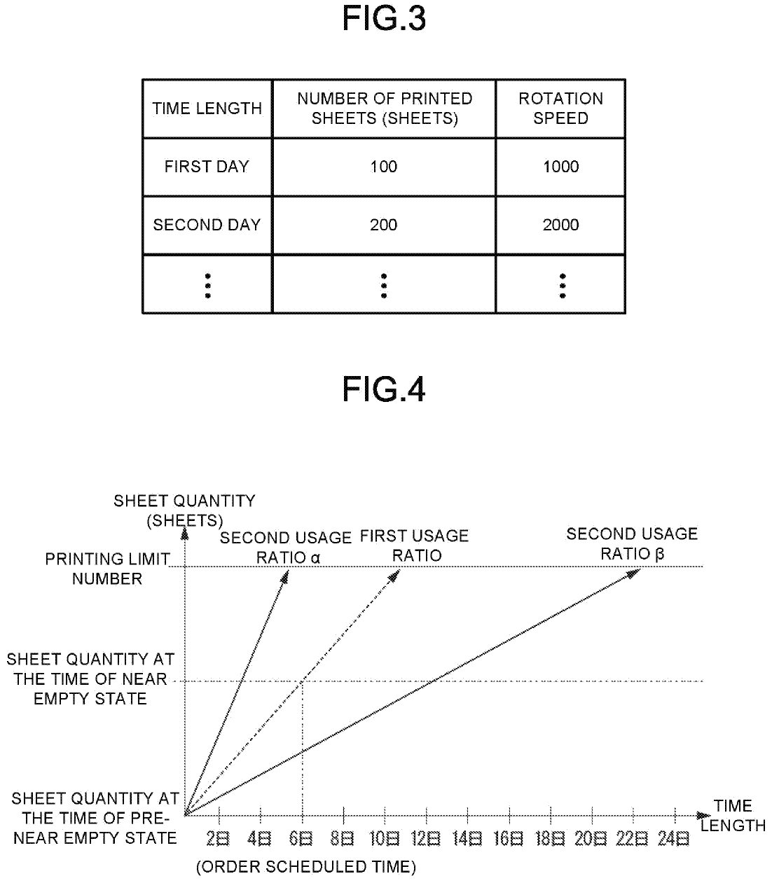

FIG. 3 is a diagram illustrating data structures of specific examples of data of the number of printed sheets and the rotation speed per day according to the first embodiment. The storage section 300a stores the toner container table. The toner container table is a data table in which the length of elapsed days, the number of printed sheets and the rotation speed are stored.

The time length counted by the time length counter 460 is stored in a column for the length of elapsed days. For example, in FIG. 3, the unit is set to one day for the data item of the length of elapsed days, and the unit may be set to any period such as one week, one month, or the like. The number of printed sheets per day counted by the sheet quantity counter 470 is stored in a column for the number of printed sheets. The rotation speed of the toner driving motor 131a is stored in a column for the rotation speed.

FIG. 4 is a graph illustrating the relationship between the number of printed sheets and the time length of the order scheduled time according to the embodiment. In FIG. 4, for example, according to the first usage ratio, the time length after reaching the printing limit number is about 10 days, and the order scheduled time of the toner is 6 days later. The calculation section 420a calculates the second usage ratio. Based on the first usage ratio, the determining section 430a sets the increase/decrease threshold value to determine whether or not the second usage ratio exceeds the increase/decrease threshold value. If the second usage ratio exceeds the increase/decrease threshold value, the decision section 440a updates the order scheduled time.

In FIG. 4, the second usage ratio in a case in which the number of printed sheets per day increases when compared with the first usage ratio is set to a second usage ratio α. The second usage ratio in a case in which the number of printed sheets per day decreases when compared with the first usage ratio is set to a second usage ratio β.

Since the number of printed sheets per day increases, if the order scheduled time according to the second usage ratio α is set to 6 days later decided according to the first usage ratio without any change, the printing cannot be performed 6 days later. Therefore, the decision section 440a decides to bring the order scheduled time forward based on the second usage ratio α. For example, in FIG. 4, the order scheduled time according to the second usage ratio α is 3 days later.

Since the number of printed sheets per day decreases, if the order scheduled time according to the second usage ratio β is set to 6 days later decided according to the first usage ratio without any change, it is necessary to hold the inventory despite that the printing can be performed. Therefore, the decision section 440a decides to put off the order scheduled time based on the second usage ratio β. For example, in FIG. 4, the order scheduled time according to the second usage ratio β is 12 days later.

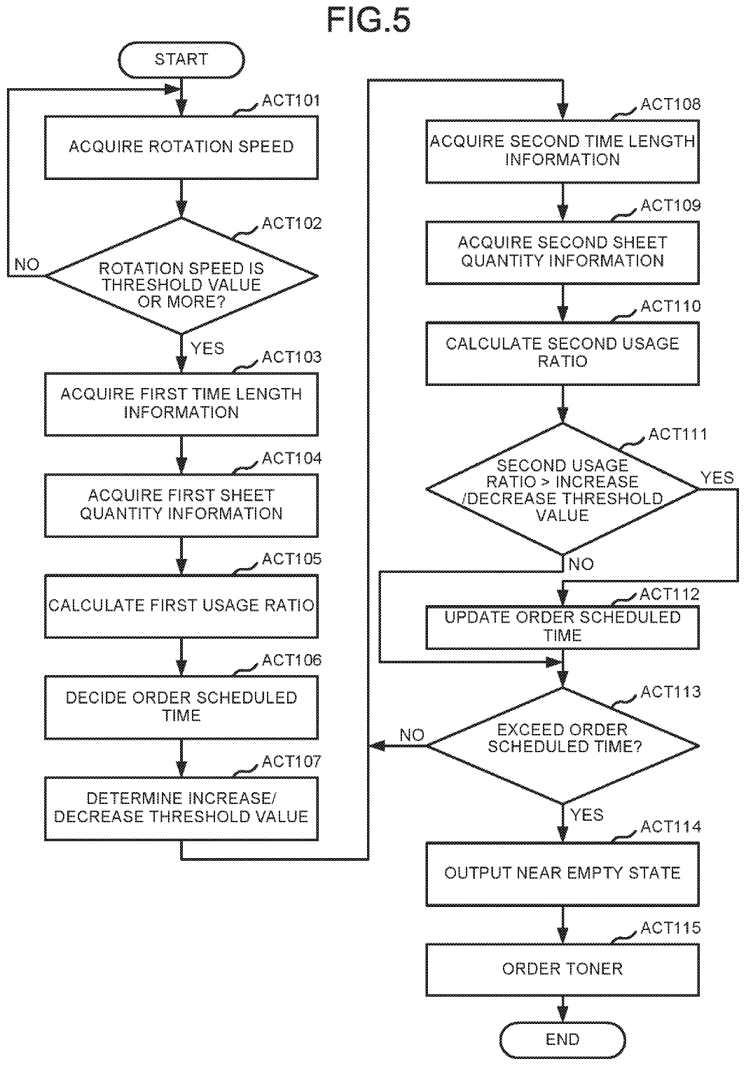

FIG. 5 is a flowchart depicting a flow of a toner order processing according to the first embodiment. In FIG. 5, the order scheduled time, which is decided first, is decided based on the first usage ratio.

The acquisition section 410a acquires the rotation speed of the toner driving motor (ACT 101). Based on the rotation speed of the toner driving motor 131a, the determining section 430a determines whether or not the rotation speed exceeds the predetermined threshold value of the rotation speed (ACT 102).

The determining section 430a transmits a command for acquiring the rotation speed to the acquisition section 410a again if the rotation speed of the toner driving motor 131a is less than the predetermined threshold value (No in ACT 102). The determining section 430a determines that the toner container shifts to the pre-near empty state if the rotation speed of the toner driving motor 131a exceeds the predetermined threshold value (Yes in ACT 102).

The acquisition section 410a acquires the first time length information indicating the time length in a period until the transition to the pre-near empty state from the replacement of the toner container (ACT 103). The acquisition section 410a acquires the first sheet quantity information which indicates the number of printed sheets and is associated with the first time length information (ACT 104). The calculation section 420a calculates the first usage ratio based on the first time length information and the first sheet quantity information (ACT 105).

The decision section 440a decides the order scheduled time based on the second time length information and the second sheet quantity information (ACT 106). The determining section 430a determines the increase/decrease threshold value based on the first usage ratio calculated by the calculation section 420a (ACT 107).

The acquisition section 410a acquires the second time length information indicating the time length in the period until the transition to the empty state from the pre-near empty state (ACT 108). The acquisition section 410a acquires the second sheet quantity information which indicates the number of printed sheets and is associated with the second time length information (ACT 109). The calculation section 420a calculates the average of the number of printed sheets per day as the second usage ratio in the period indicated by the second time length information (ACT 110).

The determining section 430a determines the increase/decrease threshold value based on the first usage ratio calculated by the calculation section 420a. The determining section 430a determines whether or not the second usage ratio is beyond a range between the two threshold values of the increase/decrease threshold value (ACT 111). If the second usage ratio exceeds the increase/decrease threshold value (Yes in ACT 111), the determining section 430a transmits a command of changing the order scheduled time to the decision section 440a based on the second usage ratio. The decision section 440a receives the command of changing the order scheduled time from the determining section 430a and updates the order scheduled time (ACT 112). After that, the flow proceeds to the processing in ACT 113.

If the second usage ratio does not exceed the increase/decrease threshold value (No in ACT 111), the determining section 430a determines whether or not the length of elapsed days exceeds the toner order time based on the second time length information (ACT 113). If the length of elapsed days does not exceed the toner order time (No in ACT 113), the determining section 430a updates the second time length information and determines the order time again. In other words, the processing in ACT 108 to ACT 113 is executed in the same way as described above again.

When the length of elapsed days exceeds the toner order time (Yes in ACT 113), the order section 450a outputs the near empty state to the image display device such as the control panel 120 (ACT 114). The order section 450a orders the toner based on the order scheduled time decided by the decision section 440a (ACT 115).

According to the image forming apparatus 100a of the first embodiment configured as described above, the automatic order of toner is performed based on the first usage ratio or the second usage ratio. Therefore, even when the use frequency of the image forming apparatus 100a changes, the image forming apparatus 100a can change the order scheduled time and make an order at an appropriate timing.

### Second Embodiment

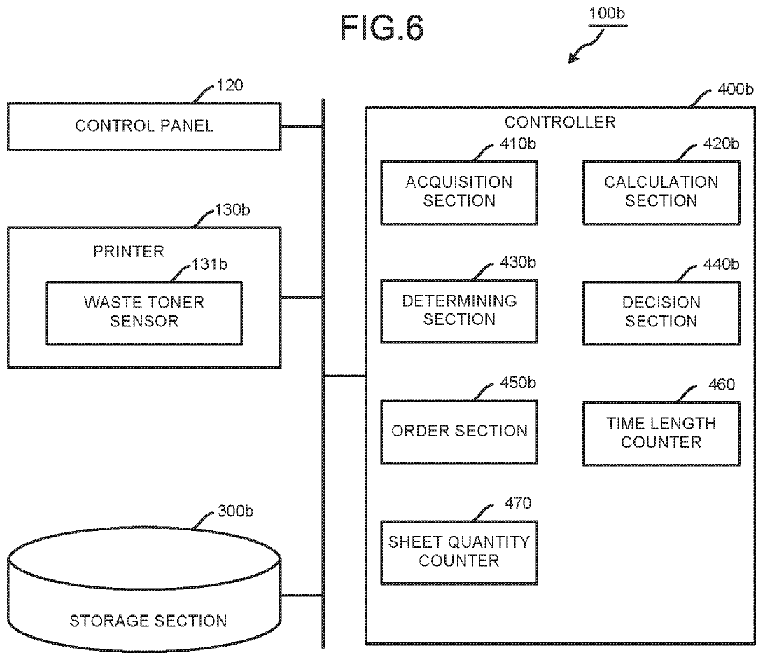

FIG. 6 is a block diagram illustrating functions of the image forming apparatus 100b according to the second embodiment. The image forming apparatus 100b comprises the control panel 120, a printer 130b, a storage section 300b and a controller 400b. The control panel 120 and the printer 130b are the same as those shown in FIG. 1, and the description thereof is omitted here.

The printer 130b includes a waste toner sensor 131b. The waste toner sensor 131b is, for example, an optical sensor, a weight sensor or the like for measuring a waste toner amount.

The storage section 300b is a storage device such as a magnetic hard disk device or a semiconductor storage device. The storage section 300b previously stores a printing limit number indicating the maximum number of printed sheets that can be printed before the toner container changes from the full state to the empty state. The storage section 300b stores, for example, a waste toner table in which a predetermined period, the number of printed sheets in the predetermined period, and a waste toner amount in the waste toner container are stored.

The controller 400b is a processor such as a CPU. By executing a program by the processor, the controller 400b functions as an acquisition section 410b, a calculation section 420b, a determining section 430b, a decision section 440b, an order section 450b, a time length counter 460 and a sheet quantity counter 470. For the items already described in the first embodiment, the description thereof may be omitted below in some cases. Here, the description is made mainly on characteristic items of the second embodiment.

The acquisition section 410b acquires first time length information, second time length information, first sheet quantity information and second sheet quantity information. The first time length information in the present embodiment indicates the time length in a period until the transition to the pre-near full state from the replacement of the waste toner container. The pre-near full state indicates a state prior to a near full state in which the order or a warning is performed when the waste toner amount increases. The near full state indicates a state in a period until the waste toner container becomes full since the waste toner amount reaches a predetermined threshold value. The second time length information indicates the time length in a period from the pre-near full state to the full state.

The acquisition section 410b acquires the waste toner amount from the waste toner sensor 131b. The acquisition section 410b transmits the first time length information, the second time length information, the first sheet quantity information, the second sheet quantity information and the waste toner amount acquired by the acquisition section 410b to the calculation section 420b and the determining section 430b. The acquisition section 410b may store the acquired data in the storage section 300b.

The calculation section 420b calculates a usage ratio indicating a usage amount per unit day based on the number of printed sheets printed during a predetermined period since the time when the waste toner container shifts to the pre-near empty state. For example, the calculation section 420b calculates the first usage ratio based on the first time length information and the first sheet quantity information. The calculation section 420b calculates the average of the number of printed sheets per day as the second usage ratio in a period indicated by the second time length information.

The determining section 430b determines whether or not the waste toner amount exceeds a predetermined threshold value based on the waste toner amount received from the waste toner sensor 131b. The determining section 430b determines that the waste toner container shifts to the pre-near full state if the waste toner amount exceeds the predetermined threshold value. The determining section 430b determines that the waste toner container does not shift to the pre-near full state if the waste toner amount is less than the predetermined threshold value. Then, if the waste toner amount is less than the predetermined threshold value, the determining section 430b transmits a command for acquiring the waste toner amount to the acquisition section 410b.

The determining section 430b determines the increase/decrease threshold value based on the first usage ratio calculated by the calculation section 420b. The determining section 430b determines whether or not the second usage ratio exceeds the increase/decrease threshold value (at least one of a threshold value in a case of increase and a threshold value in a case of decrease).

If the second usage ratio exceeds the increase/decrease threshold value, the determining section 430b transmits a command of changing the order scheduled time based on the second usage ratio to the decision section 440b. If the second usage ratio does not exceed the increase/decrease threshold value, i.e., if the second usage ratio is within the range of the increase/decrease threshold value, the determining section 430b waits for the update of the second usage ratio again.

Based on the second time length information, the determining section 430b determines whether or not the length of elapsed days exceeds the order time of the waste toner container. If the length of elapsed days exceeds the order time of the waste toner container, the determining section 430b transmits a command to order the waste toner container to the order section 450b. If the length of elapsed days does not exceed the order time of the waste toner container, the determining section 430b updates the second time length information based on the count of the time length counter 460 and makes a determination again.

The decision section 440b decides the order scheduled time based on a time point at which conditions relating to the replacement of the consumable commodity (waste toner container) are satisfied since the consumable commodity is mounted. For example, the decision section 440b determines the order scheduled time based on the second time length information and the second sheet quantity information. The decision section 440b may determine the order scheduled time based on the first usage ratio.

If the command of changing the order scheduled time is received from the determining section 430b, the decision section 440b updates the order scheduled time. At this time, if the number of printed sheets per day according to the second usage ratio increases when compared with the first usage ratio, the decision section 440b decides to bring the order scheduled time forward. If the number of printed sheets per day according to the second usage ratio decreases when compared with the first usage ratio, the decision section 440b decides to put off the order scheduled time.

The order section 450b orders the waste toner container based on the order scheduled time decided by the decision section 440b. If the order scheduled time is changed, the order section 450b orders the waste toner container based on the changed order scheduled time. The order section 450b outputs the near full state to the image display device such as the control panel 120.

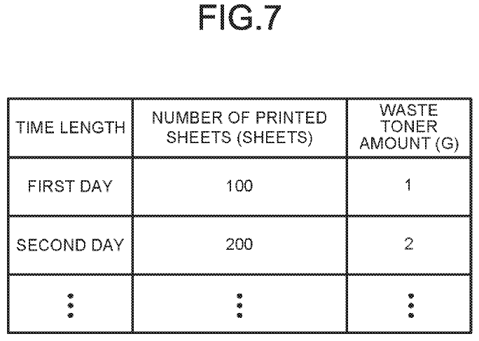

FIG. 7 is a diagram illustrating data structures of specific examples of data relating to the number of printed sheets per day and the waste toner amount according to the second embodiment. The storage section 300b stores the waste toner table. The waste toner table is a data table for storing the length of elapsed days, the number of printed sheets and the waste toner amount.

The time length counted by the time length counter 460 is stored in a column for the length of elapsed days. For example, in FIG. 7, the unit is set to one day for the data item of the length of elapsed days, and the unit may be set to any period such as one week, one month, or the like. The number of printed sheets per day counted by the sheet quantity counter 470 is stored in a column for the number of printed sheets. The waste toner amount acquired from the waste toner sensor 131b is stored in a column for the waste toner amount.

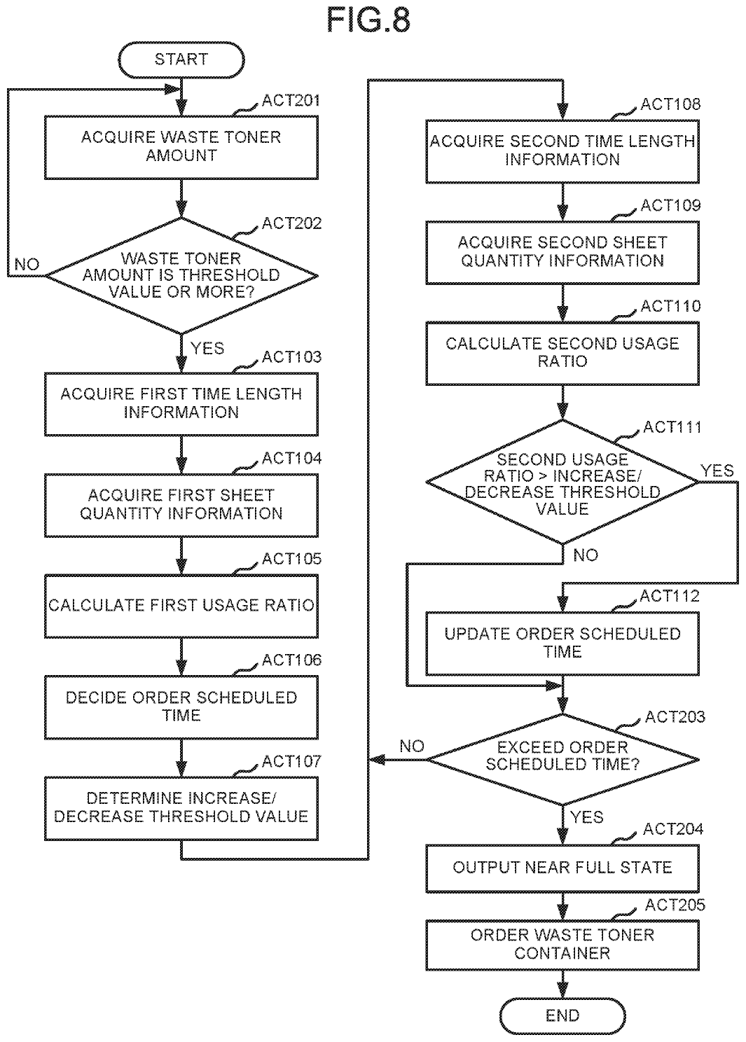

FIG. 8 is a flowchart depicting a flow of the order processing of the waste toner container according to the second embodiment. In FIG. 8, the same processing as that shown in FIG. 5 is denoted with the same reference numerals. In FIG. 8, a processing that is not shown in FIG. 5 is denoted with a different reference numeral (number in a series of ACT 200). In FIG. 8, the order scheduled time, which is decided first, is decided based on the first usage ratio.

The acquisition section 410b acquires the waste toner amount from the waste toner sensor 131b (ACT 201). The determining section 430b determines whether or not the waste toner amount exceeds a predetermined threshold value based on the acquired waste toner amount (ACT 202).

The determining section 430b transmits a command for acquiring the waste toner amount to the acquisition section 410b again if the waste toner amount is less than the predetermined threshold value (No in ACT 202). The determining section 430b determines that the waste toner container shifts to the pre-near full state if the waste toner amount exceeds the predetermined threshold value (Yes in ACT 202). Next, the processing in ACT 103 to ACT 112 is executed. In ACT 103 to ACT 112, the transition of the state is expressed as the empty state, the near empty state, and the pre-near empty state. Therefore, in the second embodiment, these states are expressed as the full state, the near full state, and the pre-near full state, respectively.

If the second usage ratio does not exceed the increase/decrease threshold value (No in ACT 111), the determining section 430b determines whether or not the length of elapsed days exceeds the order time of the waste toner container based on the second time length information (ACT 203). If the length of elapsed days does not exceed the order time of the waste toner container (No in ACT 203), the determining section 430b updates the second time length information and determines the order time again. In other words, the processing in ACT 108 to ACT 112 is executed in the same way as described above again.

If the length of elapsed days exceeds the order time of the waste toner container (Yes in ACT 203), the order section 450b outputs the near full state to the image display device such as the control panel 120 (ACT 204). The order section 450b orders the waste toner container based on the order scheduled time decided by the decision section 440b (ACT 205).

According to the image forming apparatus 100b of the second embodiment configured as described above, the automatic order of the waste toner container is performed based on the first usage ratio or the second usage ratio. Therefore, even when the use frequency of the image forming apparatus 100b changes, the image forming apparatus 100b can change the order scheduled time and make an order at an appropriate timing.

### Third Embodiment

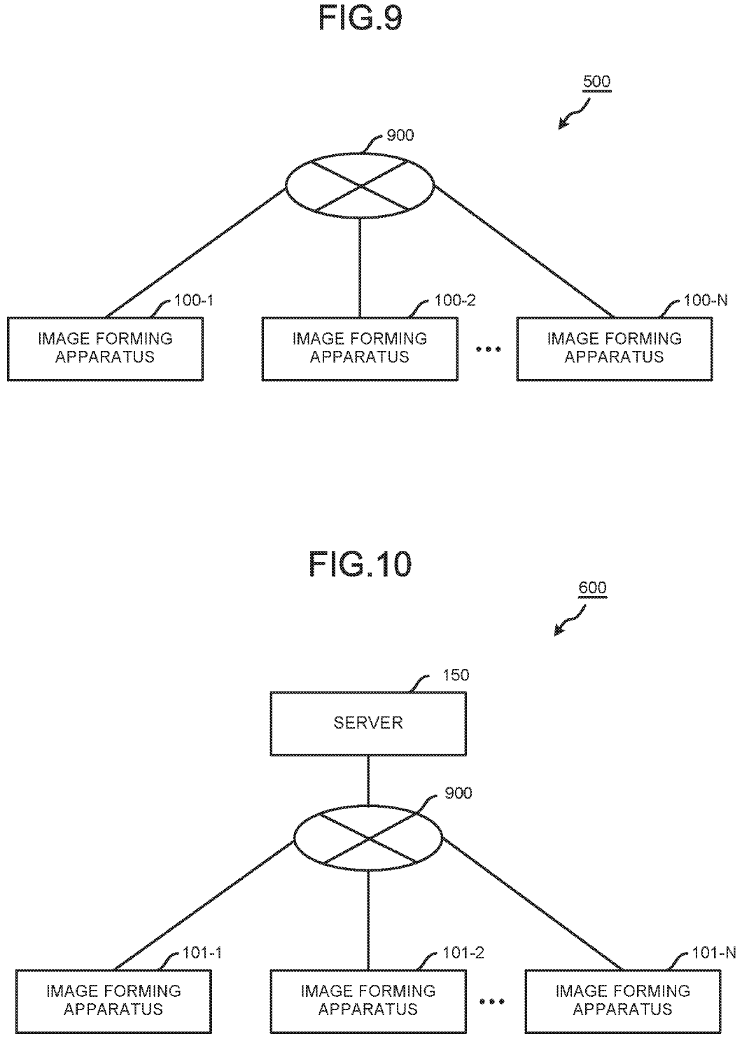

FIG. 9 is a diagram schematically illustrating a system configuration of an image forming system 500 according to the third embodiment. The image forming system 500 includes N (N is one or more) image forming apparatuses 100. The image forming system 500 is formed by connecting a plurality of the image forming apparatuses 100 to each other via a network 900. The network 900 is a network such as a LAN (Local Area Network), a WAN (Wide Area Network), the Internet, or the like.

The image forming system 500 selects one image forming apparatus 100 from the plurality of the image forming apparatuses 100 connected via the network 900 as a parent apparatus. The image forming apparatus 100 which functions as a parent apparatus controls the other image forming apparatuses 100. Hereinafter, as an example, a case in which an image forming apparatus 100-1 is the parent apparatus is described.

The image forming apparatus 100-1 acquires conditions relating to replacement of the consumable commodity from one or more image forming apparatuses 100-N. The image forming apparatus 100-1 decides the order scheduled time of each image forming apparatus 100-N based on the condition relating to the replacement of the consumable commodity. At this time, the image forming apparatus 100-1 also decides its own order scheduled time. The methods of deciding and changing the order scheduled time are the same as those described in the first embodiment and the second embodiment, and the description thereof is therefore omitted.

According to the image forming system 500 of the third embodiment configured as described above, one image forming apparatus 100 is selected from the image forming apparatuses 100 as the parent apparatus. The image forming apparatus 100, which functions as the parent apparatus, acquires conditions relating to replacement of the consumable commodity from the other image forming apparatuses 100. Then, the image forming apparatus 100, which functions as the parent apparatus, performs automatic order of the toner and the waste toner container of the image forming apparatus 100 based on the first usage ratio or the second usage ratio. As a result, the image forming apparatus 100, which functions as the parent apparatus, can change the order scheduled time and make an order at an appropriate timing even when the use frequencies of the image forming apparatus 100 itself and the other image forming apparatuses 100 change.

### Fourth Embodiment

FIG. 10 is a diagram schematically illustrating a system configuration of an image forming system 600 according to the fourth embodiment. The image forming system 600 includes N (N is one or more) image forming apparatuses 101 and a server 150. The image forming system 600 is constituted by connecting a plurality of the image forming apparatuses 101 and the server 150 to each other via a network 900. The network 900 is a network such as a LAN, a WAN, the Internet, or the like.

The server 150 acquires the condition relating to replacement of the consumable commodity from each image forming apparatus 101 and determines the order scheduled time of each image forming apparatus 101.

The image forming apparatus 101 notifies the server 150 of the information relating to the replacement of the consumable commodity (the number of printed sheets and the waste toner amount).

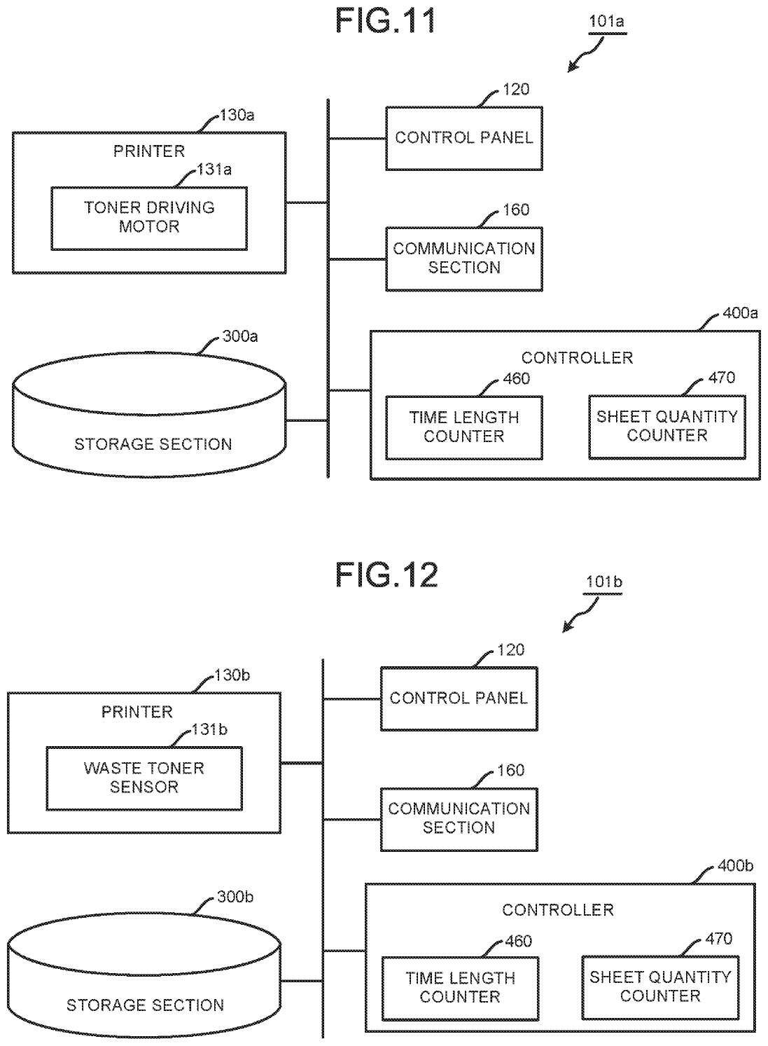

FIG. 11 is a block diagram illustrating functions of an image forming apparatus 101a according to the fourth embodiment. The image forming apparatus 101a includes the control panel 120, the printer 130a, a communication section 160, the storage section 300a, and the controller 400a. The control panel 120, the printer 130a, and the storage section 300a are the same as those shown in FIG. 2, and thus, the description thereof is omitted.

The communication section 160 is a communication interface. The communication section 160 performs data communication with the other image forming apparatuses 101 and the server 150 via the network 900.

The controller 400a is a processor such as a CPU. By executing a program by the processor, the controller 400a functions as the time length counter 460 and the sheet quantity counter 470. The time length counter 460 and the sheet quantity counter 470 are the same as those shown in FIG. 2, and thus, the description thereof is omitted here.

FIG. 12 is a block diagram illustrating functions of an image forming apparatus 101b according to the fourth embodiment. The image forming apparatus 101b includes the control panel 120, the printer 130b, the communication section 160, the storage section 300b, and the controller 400b. The control panel 120, the printer 130b and the storage section 300b are the same as those shown in FIG. 6, and thus, the description thereof is omitted here.

The communication section 160 is a communication interface. The communication section 160 performs data communication with the other image forming apparatuses 101 and the server 150 via the network 900.

The controller 400b is a processor such as a CPU. By executing the program by the processor, the controller 400b functions as the time length counter 460 and the sheet quantity counter 470. The time length counter 460 and the sheet quantity counter 470 are the same as those shown in FIG. 2, and thus, the description thereof is omitted here.

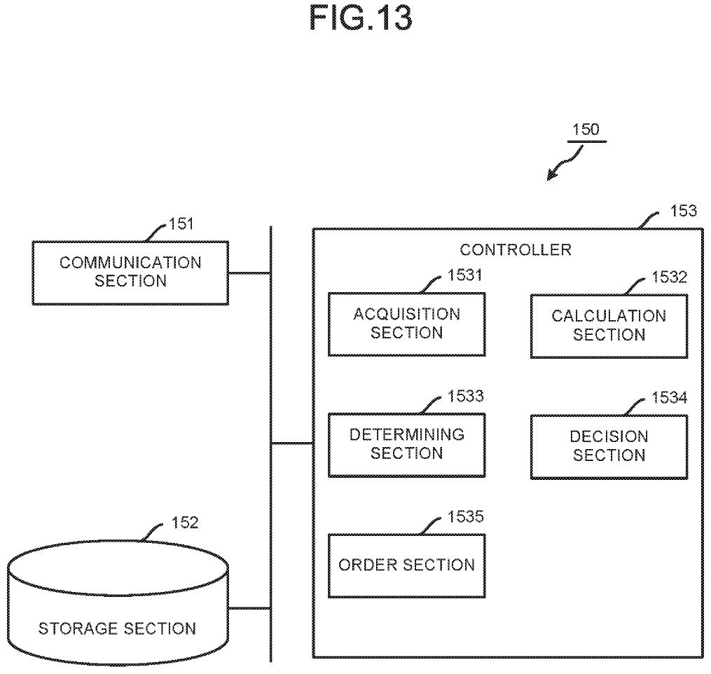

FIG. 13 is a block diagram illustrating functions of the server 150 according to the fourth embodiment. The server 150 includes a communication section 151, a storage section 152, and a controller 153.

The communication section 151 is a communication interface. The communication section 151 performs data communication with the image forming apparatus 101 via the network 900.

The storage section 152 is a storage device such as a magnetic hard disk device or a semiconductor storage device. The storage section 152 previously stores a printing limit number indicating the maximum number of printed sheets that can be printed before the state of the toner container changes from the full state to the empty state.

For example, the storage section 152 stores a toner container table in which a predetermined period, the number of printed sheets in the predetermined period, and a rotation speed of the toner driving motor 131a are stored. For example, the storage section 152 stores a waste toner table in which a predetermined period, the number of printed sheets in the predetermined period, and a waste toner amount in the waste toner container are stored. For example, the storage section 152 may store information relating to the replacement of a consumable commodity (the number of printed sheets and the waste toner amount) received from the image forming apparatus 101.

The controller 153 is a processor such as a CPU. By executing a program by the processor, the controller 153 functions as an acquisition section 1531, a calculation section 1532, a determining section 1533, a decision section 1534, and an order section 1535.

The acquisition section 1531 acquires the first time length information, the second time length information, the first sheet quantity information and the second sheet quantity information from the image forming apparatus 101. The first time length information in the present embodiment indicates at least one of a period until the transition to the pre-near full state since the waste toner container is replaced and a period until the transition to the pre-near empty state since the toner container is replaced. The second time length information in the present embodiment indicates at least one of a period until the transition to the empty state from the pre-near empty state and a period until the transition to the full state from the pre-near full state. The detailed processing content of the acquisition section 1531 is the same as that of the acquisition section 410a and the acquisition section 410b, and thus, the description thereof is omitted here.

The calculation section 1532 calculates the usage ratio from the number of printed sheets per unit day. For example, the calculation section 1532 calculates the usage ratio indicating a usage amount per unit day based on the number of printed sheets printed in the predetermined period since a time point at which the toner container shifts to the pre-near empty state. For example, the calculation section 1532 calculates the usage ratio indicating the usage amount per unit day based on the number of printed sheets printed in a predetermined period from the time point at which the waste toner container shifts to the pre-near full state. The detailed processing content of the calculation section 1532 is the same as that of the processing section 420a and the calculation section 420b, and thus, the description thereof is omitted here.

The determining section 1533 determines the order scheduled time based on the second time length information and the second sheet quantity information. Based on the waste toner amount received from the waste toner sensor 131b, the determining section 1533 determines whether or not the waste toner amount exceeds a predetermined threshold value. The detailed processing content of the determining section 1533 is the same as that of the determining section 430a and the determining section 430b, and thus, the description thereof is omitted here.

The decision section 1534 decides the order scheduled time based on the time point at which a condition relating to replacement of the consumable commodity is satisfied since the consumable commodity (the waste toner container) is mounted. The detailed processing content of the decision section 1534 is the same as that of the decision section 440a and the decision section 440b, and thus, the description thereof is omitted here.

The order section 1535 orders the toner and the waste toner container based on the order scheduled time decided by the decision section 1534. If the order scheduled time is changed, the order section 1535 orders the toner and the waste toner container based on the changed order scheduled time. The detailed processing content of the order section 1535 is the same as that of the order section 450a and the order section 450b, and thus, the description thereof is omitted here.

According to the image forming system 600 of the fourth embodiment configured as described above, by providing the server 150, it is possible to acquire the condition relating to the replacement of the consumable commodity (the number of printed sheets and the waste toner amount) from the image forming apparatus 101. The server 150 can then automatically order the toner and the waste toner container of the image forming apparatus 101 based on the first usage ratio or the second usage ratio. As a result, even when the use frequency of the image forming apparatus 101 changes, the server 150 can change the order scheduled time and make an order at an appropriate timing.

### MODIFICATION

The storage section 300a and the storage section 300b may store any of the rotation speed of the toner driving motor 131a, the waste toner amount acquired from the waste toner sensor 131b, calculation results of the calculation section 420a and the calculation section 420b, determination results of the determining section 430a and the determining section 430b, decision results of the decision section 440a and the decision section 440b, the order scheduled time of the order section 450a and the order section 450b, the time length counted by the time length counter 460, and the number of printed sheets counted by the sheet quantity counter 470.

The predetermined period which is a criterion for the time length counter 460 to bring the count forward is defined as one day, but an arbitrary period such as one week or one month may be defined as the predetermined period which is a criterion for bringing the count forward.

The decision section 440a may decide a time point at which the condition is satisfied (the time point at which the order scheduled time is decided first) as a start point. The decision section 440a may decide the order scheduled time decided at the time point at which the condition is satisfied as an end point. The decision section 440a may decide the order scheduled time according to the number of printed sheets in a predetermined period until the decided order scheduled time from the time point at which the condition is satisfied.

The order section 450a may notify a user of a warning about exhaustion of the toner, or may not output the near empty state. The order section 450b may notify the user of a warning about the waste toner amount or may not output the near full state.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. An image forming apparatus comprising:
a decision section configured to update an order scheduled time of a consumable commodity used in the image forming apparatus,
wherein the decision section is configured to update the order scheduled time based on:
a time period from the mounting of the consumable commodity on the image forming apparatus until reaching a time point at which a condition related to a remaining amount of the consumable commodity is satisfied; and
a number of sheets printed in a predetermined period after the time point at which the condition is satisfied.

2. The image forming apparatus according to claim 1, further comprising a determining section configured to determine whether a usage ratio indicating the use frequency of the image forming apparatus exceeds a predetermined threshold value or not, wherein the decision section is configured to decide whether to change the order scheduled time based on a determination result of the determining section.

3. The image forming apparatus according to claim 2, wherein the determining section is configured to calculate the usage ratio indicating a usage amount per time unit in a time period until the time point at which the condition is satisfied since the consumable commodity is mounted on the image forming apparatus based on the number of printed sheets in the period and the time length of the period, and sets the threshold value based on the usage ratio.

4. The image forming apparatus according to claim 3, further comprising an acquisition section configured to acquire a remaining amount of a toner in a toner container, wherein the consumable commodity mounted to the image forming apparatus is the toner.

5. The image forming apparatus according to claim 4, wherein
the acquisition section is further configured to acquire a rotation speed of a motor for operating the toner container, and
the determining section is configured to determine a proportion of the remaining amount of the toner according to the rotation speed.

6. The image forming apparatus according to claim 5, wherein the decision section is configured to decide a state of the remaining amount of the toner based on the determination result of the determining section.

7. The image forming apparatus according to claim 6, wherein the acquisition section is configured to acquire a waste toner amount indicating an amount of waste toner in a waste toner container which is the consumable commodity.

8. The image forming apparatus according to claim 7, wherein:
the acquisition section is further configured to acquire the waste toner amount in the waste toner container, and
the determining section is configured to determine a proportion of the waste toner amount to the container according to the waste toner amount.

9. The image forming apparatus according to claim 8, wherein the decision section is configured to decide a state of the waste toner amount based on the determination result of the determining section.

10. An image forming system comprising an image forming apparatus and a server, wherein the image forming apparatus comprises:
an acquisition section configured to acquire a remaining amount of a consumable commodity mounted to the image forming apparatus; and
a communication section configured to notify the server of the remaining amount of the consumable commodity, which indicates information relating to replacement of the consumable commodity, and
wherein the server, upon receiving the notification from the communication section of the image forming apparatus, updates an order scheduled time of the consumable commodity based on a time point at which the consumable commodity information satisfies a predetermined condition, and updates the order scheduled time based on a number of sheets printed in a predetermined period after the time point at which the predetermined condition is satisfied.

11. The image forming system of claim 10, wherein the image forming apparatus further comprises a determining section configured to determine whether a usage ratio indicating the use frequency of the image forming apparatus exceeds a predetermined threshold value or not, wherein the decision section decides whether to change the order scheduled time based on a determination result of the determining section, wherein the determining section calculates the usage ratio indicating a usage amount per time unit in a time period until the time point at which the condition is satisfied since the consumable commodity is mounted on the image forming apparatus based on the number of printed sheets in the period and the time length of the period, and sets the threshold value based on the usage ratio.

12. The image forming system of claim 11, wherein
the acquisition section of the image forming apparatus further acquires a rotation speed of a motor for operating the toner container, and
the determining section of the image forming apparatus determines a proportion of the remaining amount of the toner according to the rotation speed.

13. An image forming device comprising:
a printer consuming a consumable commodity installed in the image forming device;
a storage section connected to the printer, the storage section storing a time period for ordering a replacement for the consumable commodity; and
a controller connected to the printer by sending and receiving various signals, wherein the controller is operable to output a signal to the storage section for updating the replacement for the consumable commodity, wherein the controller measures a rate of consumption of the consumable commodity based on a number of printed sheets over time and determines a difference between the measured rate of consumption and a default rate of consumption determined based on an expected number of printed sheets over the stored time period and updates the storage section with a new time period for ordering a replacement for the consumable commodity when the difference exceeds a value.

14. The image forming device of claim 13, wherein the controller comprises an acquisition section for determining a rate at which the printer is using the consumable commodity.

15. The image forming device of claim 14, wherein the acquisition section determines a remaining amount of a toner; and wherein the consumable commodity mounted to the image forming device is the toner.

16. The image forming device of claim 14, wherein the controller further comprises a decision section configured to update the time period for ordering the replacement based on a time period when reaching a time point at which a condition related to replacement of the consumable commodity is satisfied since the consumable commodity is mounted to the image forming device, wherein the decision section updates the time period based on a number of sheets printed in a predetermined period after the time point at which the condition is satisfied.

17. The image forming device of claim 16, wherein the controller further comprises a determining section configured to determine whether the rate of consumption indicating the use frequency of the image forming apparatus exceeds a predetermined threshold value or not, wherein the decision section decides whether to change the order scheduled time based on a determination result of the determining section, wherein the determining section calculates the rate of consumption indicating a usage amount per time unit in a time period until the time point at which the condition is satisfied since the consumable commodity is installed in the image forming device based on the number of printed sheets in the period and the time length of the period, and sets the threshold value based on the usage ratio.

18. The image forming device of claim 17, wherein:
the acquisition section further acquires a rotation speed of a motor for operating the toner container,
the determining section determines a proportion of the remaining amount of the toner according to the rotation speed, and
the decision section decides a state of the remaining amount of the toner based on the determination result of the determining section.

19. A method for updating a scheduled time for ordering a replacement for a consumable commodity used in a printing device, the method comprising:
storing, in a storage section of the printing device, the scheduled time based on an installation of the consumable commodity;
monitoring, in an acquisition section of a controller of the printing device, a use of the installed consumable commodity;
calculating, in a calculation section of the controller of the printing device, a rate of consumption of the consumable commodity;
determining, at a determination section of the controller of the printing device, a difference between the measured rate of consumption based on a number of printed sheets over time and a default rate of consumption determined based on an expected number of printed sheets over the stored time period; and
updating, in the storage section, the stored scheduled time with a new time period for ordering the replacement for the commodity when the difference exceeds a value.

20. The method of claim 19, wherein monitoring the use of the installed consumable commodity and updating the stored scheduled time with the new time period are based on a time period from the installation of the consumable commodity on the image forming apparatus until reaching a time point at which a condition related to replacement of the consumable commodity is satisfied; and the number of sheets printed in a predetermined period after the time point at which the condition is satisfied.
